(19) United States
(12) Patent Application Publication
(10) Pub. No.: US 2020/0134715 A1
(43) Pub. Date: Apr. 30, 2020

(54) Crowdvouching

(71) Applicant: Evgenii Lobachev, Grand Cayman (KY)

(72) Inventor: Evgenii Lobachev, Grand Cayman (KY)

(21) Appl. No.: 16/176,548

(22) Filed: Oct. 31, 2018

(51) Int. Cl. G06Q 40/02; G06Q 40/06

(52) U.S. Cl. CPC G06Q 40/025; G06F 17/30424; G06Q 40/06

(57) ABSTRACT

A method for securing loan repayments by vouching monetary contributions from multiple guarantors on a platform, whereby borrowers submit loan requests to a database and guarantors search the database and select borrowers they want to vouch for. The guarantors then consent to act as guarantors on loans made to the selected borrowers and, in addition, make an investment by contributing funds to an intermediary which is kept safely in escrow that will be released to the lender in case of default by borrower. The lender lends money to the selected borrowers. The resulting guarantor-guaranteed loans are serviced by the intermediary for a commission.

### FIELD OF THE INVENTION

This invention relates to methods established to assist borrowers seeking credit. In particular, it relates to the coordination of loans, and loan guarantees from guarantors, via a specific platform which can be a website or a software application.

### BACKGROUND OF THE INVENTION

A variety of both personal and commercial entities have recognized the internet as an important new medium for communication. Because it facilitates a speedy and inexpensive exchange of information, there are countless opportunities to exploit this unique technology. As a result, the internet has now become a preferred method for transacting business and is also widely used to start and strengthen personal relationships.

Among the commercial entities exploiting the internet's possibilities are many engaged in the practice of arranging or making loans. Numerous websites and/or online auction systems enabling lenders and borrowers to locate one another have been created, and additional related efforts will almost certainly follow.

Though various methods are known for accomplishing loan transactions using the internet, much of the prior art is generally focused on transferring traditional loan processing techniques to the online environment. That is, the internet is merely used to provide an alternative connection between existing lenders and borrowers seeking credit. The vast resources and economies of scale offered by the internet do allow for comparison/shopping opportunities that were less manageable before (such as permitting a borrower to apply for credit from a multitude of lending institutions without having to physically go to or call each lender and fill out an application), but the end results of these transactions resemble traditional practices for the most part.

More innovative ventures in this arena offer loan participation networks and peer-to-peer lending models. Some of these arrangements hold particular appeal to certain user groups less inclined towards traditional credit practices.

Although the above methods have value, yet they might not be suitable for all users. For example, some individuals may prefer to provide a source of funding for loans in exchange for a potential return on their investment.

On the other side are users who need credit and desire to obtain loans. Yet some potential borrowers might not qualify for loans under existing peer-to-peer lending arrangements or online models governed by conventional underwriting constraints.

Therefore, an online lending format which overcomes these and other limitations—resulting in an entirely novel approach to coordinating loans—would be useful. The method of the present invention provides such a format. The present invention addresses the risk of default associated with unsecured loans by enabling lenders to be paired with guarantors such that the unsecured loan can be insured against default. This encourages investors who may not normally be willing to take the risk of loaning money without collateral to make these unsecured loans to borrowers.

### SUMMARY OF THE INVENTION

It is therefore an object of the present invention to provide a convenient process by which borrowers can obtain loans, lenders can earn a return on an investment while being certain they will not lose their funds in events of default.

It is a further object of the present invention to provide a distinctive avenue for borrowers with very poor credit history to obtain a shot term loan.

To achieve these and other objects of the invention, there is provided a method for coordinating borrower/guarantor relationships between or among the platform users. Guarantors contribute funding to an intermediary and agree to serve as third-party loan guarantors for specific guarantor-selected borrowers. The lender advance the loans to the selected borrowers through the intermediary. In exchange for their guarantees, the guarantors receive a return on their investment as the loans are repaid. The intermediary acts as a third party allowing the lender to lend to the borrowers and guarantors to earn a commission upon loan repayment. Guarantors select borrowers based on borrower credit status on the platform as well as other information provided to the intermediary, by borrowers, for display to guarantors. This other information allows for a social networking that can both: (i) help borrowers attract potential guarantors; and (ii) enable guarantors to make their guarantor decisions based on specific borrower attributes in addition to borrower credit status.

Multiple guarantors could manage the process. For example, one guarantor could provide $3, another one $4 and another one $3 to secure a borrower loan of $10.

Responsibility for processing loan payments as well as responsibility for taking enforcement action upon borrower default rests with the intermediary. But because the guarantors serve as guarantors for the borrower loans, guarantors bear the risk of borrower default. The return on investment earned by guarantors is dependent upon borrowers' timely/eventual repayment of loan principal amounts plus required interest and any late fees.

In a preferred embodiment of the method of the present invention, guarantor contributions would be used to secure loans for a plurality of borrowers, and guarantors will serve as guarantor only to the extent of their participation percentage in a specific loan (meaning that each borrower loan will be guaranteed by a plurality of guarantors). In the event that a loan does not reach the required amount owing to a lack of guarantors, the loan securing process fails and each guarantor is returned its contribution.

The risk of a specific borrower's default will be spread among multiple guarantors. This would serve to help maintain guarantor confidence in the system as well as maximize positive lender return-on-investment through diversification.

Ideally the method of the present invention employs a software system comprised of an Internet-accessible database storing credit and other data from users seeking loans. The system further comprises a database management program for searching the database. Guarantors search the database to identify select borrowers based on information in the system. Once identified, a guarantor transmits to the system their consent to act as a guarantor for the selected borrowers. The guarantor also authorizes a transfer of funds to the intermediary. The borrower lends funds to the guarantor-selected borrowers and processes loan payments as they are made, forwarding to the guarantor's account their share of the commission.

Borrower searches can be permitted in addition to guarantor searches. For example, as will be described below, borrowers can solicit guarantor attention by searching for specific user groups.

In a preferred embodiment, the system includes a website or an app which makes clear to users the method of the present invention and which takes borrowers/guarantors step-by-step through the lending/investing process.

### BRIEF DESCRIPTION OF THE DRAWINGS

FIG. 1 is a flow chart showing the method of an illustrative embodiment.

### DETAILED DESCRIPTION AND OPERATION

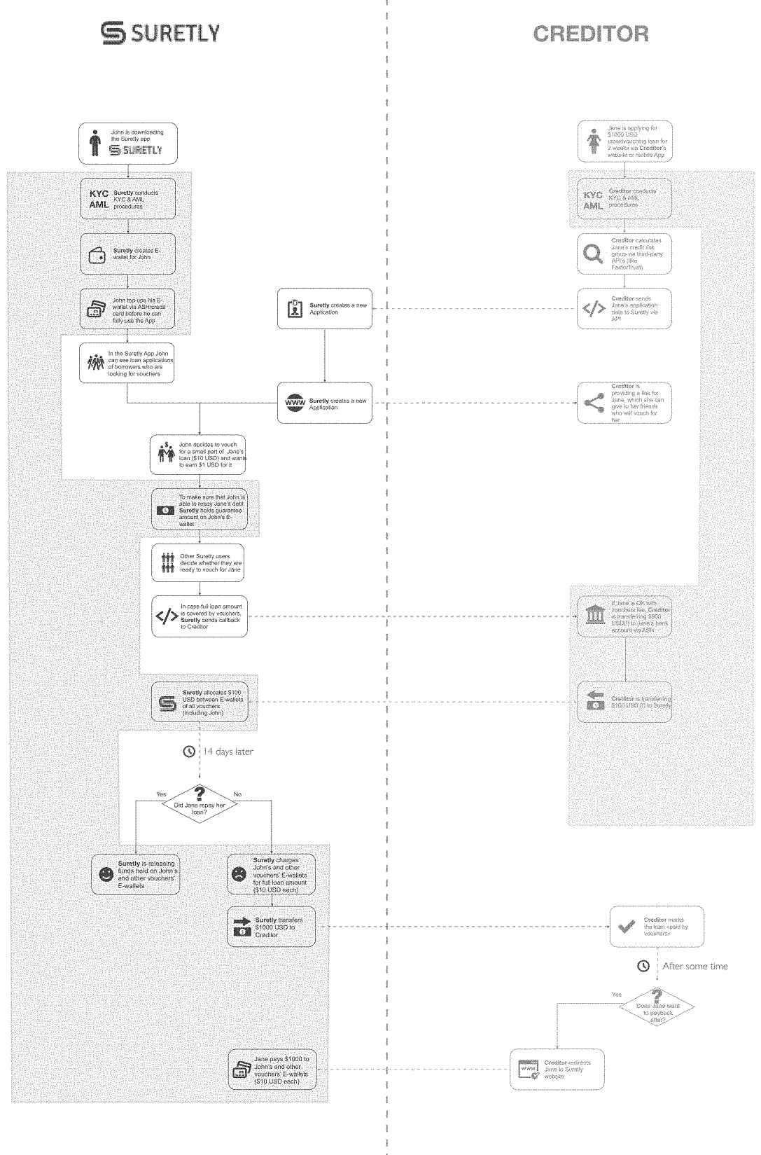

Referring to FIG. 1, there is shown a flow chart of an illustrative embodiment. A prospective borrower, seeking a loan, submits, via the app, a loan request to a database operated by the intermediary. Preferably the loan request includes a requested loan principal and might also, as discussed below, include personal information about the prospective borrower as well as the purpose of the loan request.

In submitting the loan request, the prospective borrower might authorize the intermediary to access and use personal credit data of the prospective borrower as maintained by the intermediary. The loan request is stored in the database. If used, the personal credit status is also stored in the database—or stored in a separate database—in accordance with proper security practices. In one embodiment of the invention, the intermediary provides a viewable rating for the prospective borrower derived from the prospective borrower's personal credit history on the platform.

On the other side of the transaction, a prospective guarantor searches the database via the app for an investment opportunity. The investment opportunity takes the form of a loan request that appeals to the guarantor. If, as discussed above, the intermediary has given a prospective borrower a viewable rating derived from that borrower's personal credit data, the viewable rating or status might be displayed in the prospective guarantor's search results to assist the prospective guarantor in making the investment decision.

The prospective Guarantor decides how much he wants to earn for the transaction and specifies a rate.

If the prospective guarantor decides that the prospective borrower's loan request is an acceptable investment opportunity, the prospective guarantor can make the investment to the intermediary's escrow account. The prospective guarantor actually authorizes a transfer of funds to the intermediary for the amount of the investment and also agrees to act as guarantor for the loan to the prospective borrower to the extent of the investment—thereby becoming an guarantor. (As an example, if a borrower obtains a $10 loan from ten separate guarantor/guarantors who each invested $1 in the loan, individual guarantor/guarantors would only serve as guarantor for their respective $1 share of the loan. Each guarantor/guarantor's potential loss on the loan would be limited to $1.)

To complete the transaction, the lender then transfers to an account used by the prospective borrower an amount equal to the requested loan principal. At this point, the transaction becomes a loan, the requested loan principal becomes the principal balance, and the prospective borrower then becomes a loan recipient.

The loan is serviced by the intermediary. When the loan recipient makes a payment on the loan, the intermediary remits to an account used by the Lender an amount equal to the lender's share of these proceeds.

As stated above, a particular loan can be guaranteed by pooled contributions from a plurality of guarantor/guarantors, thus spreading the risk of loan recipient default.

Friends and families can also vouch for a borrower, and the lender will share a link with the borrower which the borrower can send to his/her friends and family members to vouch for his/her loan. This will also allow automatic charges to be made by the intermediary

As a still further embodiment of the present invention can include the use of cryptocurrencies to enable users to users to borrow, lend and secure the loans. Tokens, which can be the intermediary's own token or any third party's, can be used as a guarantee and have to be enrolled to the account in the app. After the loan is approved, the tokens get frozen in the amount according to the exchange rate.

Although the description above contains several specificities, these should not be construed as limiting the scope of the present invention, but as merely providing illustrations of some of the presently preferred embodiments. It is to be therefore understood that many changes and modifications by one of ordinary skill in the art are considered to be within the scope of the invention. Thus the scope of the invention should be determined by the appended claims and their legal equivalents, rather than by examples given.

1. A method for securing loan repayments by vouching monetary contributions from multiple guarantors on a platform, comprising the steps of:
receiving a loan request from a prospective borrower;
storing the loan request in a database;
a prospective guarantor searching the database;
the prospective guarantor selecting the prospective borrower;
the prospective guarantor agreeing to act as a guarantor on a loan to the prospective borrower;
the guarantor making an investment by contributing funds to an intermediary;
the lender making a loan to the prospective borrower, the prospective borrower becoming a loan recipient.
the loan being guaranteed by the prospective guarantor, the prospective guarantor becoming an guarantor/guarantor.

2. The method of claim 1, wherein the loan is guaranteed by more than one guarantor/guarantor.

3. The method of claim 1, including more than one lender.

4. The method of claim 1, including more than one database.

5. The method of claim 1, further comprising the step of the prospective borrower searching the database.

6. The method of claim 1, including more than one loan recipient and/or more than one guarantor/guarantor.

7. A method for coordinating guarantor-guaranteed loans on a platform, wherein a prospective borrower submits via the platform a loan request to a database;
the loan request being stored in the database;
a prospective guarantor searches the database via the app or website and the search produces a search results;
the search results being the prospective borrower's loan request;
the prospective guarantor then agreeing to guarantee all or a portion of a loan to the prospective borrower made by a lender;
the prospective guarantor making an investment by contributing funds to the intermediary;
the lender lends money to the prospective borrower.

8. The method of claim 7, wherein the search results include a viewable rating or status for the prospective borrower.

9. The method of claim 7, wherein the loan to the prospective borrower is guaranteed by more than one prospective guarantor.

10. The method of claim 7, further including cryptocurrency features.

11. The method of claim 7, including more than one lender.

12. A method for coordinating guarantor-guaranteed loans via an app or website whereby:
prospective borrowers submit loan requests to a database, and the loan requests present investment opportunities for prospective guarantors;
the prospective guarantors search the database for investment opportunities;
the prospective guarantors select investment opportunities and agree to serve as guarantors on loans made by a lender to the prospective borrowers whose loan requests created the selected investment opportunities;
the prospective guarantors make investments by transferring funds to the intermediary, and the prospective guarantors become guarantor/guarantors.
the lender lends money to the prospective borrowers, and the prospective borrowers become loan recipients.

13. The method of claim 12, wherein the loan requests include personal details and/or other information about prospective borrowers.

14. The method of claim 12, wherein the database includes cryptocurrency features.

15. The method of claim 12, wherein more than one database is employed.

16. The method of claim 12, including more than one lender.

17. The method of claim 12, wherein the prospective borrowers have the option of including a viewable rating or status in their loan requests.
